(19) United States
(12) Patent Application Publication
(10) Pub. No.: US 2015/0065104 A1
(43) Pub. Date: Mar. 5, 2015

(54) METHOD AND SYSTEM FOR STATUS NOTIFICATIONS FOR CONFERENCES

(71) Applicant: BLACKBERRY LIMITED, Waterloo (CA)

(72) Inventors: Thaddeus Clark WHITE, Mountain View, CA (US); Raymond Lee CANTON, Ottawa (CA); Monica ZACZYNSKI, Ottawa (CA); Remi Wesley OGUNDOKUN, Ottawa (CA)

(73) Assignee: BLACKBERRY LIMITED, Waterloo, ON (CA)

(21) Appl. No.: 14/015,953

(22) Filed: Aug. 30, 2013

(51) Int. Cl. H04M 3/56

(52) U.S. Cl. CPC H04M 3/565
USPC 455/416

(57) ABSTRACT

A method, mobile communication device, and computer-readable storage medium are provided for displaying a message associated with a received first request for establishing a connection to a conference call; receiving, on the mobile communication device, a delay option selection; displaying, based on the received delay option selection, a plurality of delay-time options, each of the plurality of delay-time options providing a delay time for establishing a connection to the conference call; and receiving a selection of one of the plurality of delay-time options associated with a time for establishing a connection to the conference call.

### FIELD

The present disclosure generally relates to conferencing using mobile communication devices. Example embodiments relate to methods and systems for connecting a mobile communication device to a conference call, which can include an audio conference call and a video conference call.

### BACKGROUND

A mobile communication device, such as a handheld device, a multiple-mode communication devices configured for both data and voice communication, a smartphone, a mobile telephone, a netbook, a gaming console, a tablet, or a personal digital assistants (PDAs) enabled for wireless communication, is often used for making conference calls when the user of the mobile communication device does not have other alternative communication ways, such as a landline telephone device, or when the user simply prefers to use the mobile communication device to make the conference call. Typically, to join the conference call at a scheduled conference time, a conference participant needs to, for example, unlock his or her mobile communication device, open a calendar or email application, find the appropriate meeting, open the meeting event to obtain the details of the meeting, dial the conference call phone number, enter an access code, and enter a participant's code. If the conference participant is running late to join the conference, the conference participant then needs to open a messaging or an email application, compose a message or an email, and send it to the host and/or other conference participants. The whole process is cumbersome because it requires many actions from the user of the mobile communication device, especially when the user is driving or in a situation that makes it difficult to complete all the actions.

### BRIEF DESCRIPTION OF THE DRAWINGS

Reference will now be made to the accompanying drawings showing example embodiments of this disclosure. In the drawings:

FIG. 1 is a block diagram of an example network environment, consistent with embodiments of the present disclosure;

FIG. 2 is a simplified block diagram illustrating an example mobile communication device, consistent with embodiments of the present disclosure;

FIG. 3 illustrates an example graphical user interface provided on a mobile communication device after receiving a first request from a network server for connecting to a conference call, consistent with embodiments of the present disclosure;

FIGS. 4A-4C illustrate example graphical user interfaces provided on a mobile communication device corresponding to the user's responses to the first request for connecting to the conference call, consistent with embodiments of the present disclosure;

FIGS. 5A-5B illustrate example graphical user interfaces provided on a mobile communication device for delaying the connection to the conference call, consistent with embodiments of the present disclosure;

FIGS. 6A-6B illustrate example graphical user interfaces provided on a receiving mobile communication device for receiving a delay notification from the network server, consistent with embodiments of the present disclosure;

FIGS. 7A-7C illustrate example graphical user interfaces providing an attendee list on a receiving mobile communication device, consistent with embodiments of the present disclosure;

FIG. 8 illustrates an example graphical user interface provided on a snoozing device after receiving a second request from a network server for connecting to a conference call after the delay time elapses, consistent with embodiments of the present disclosure;

FIG. 9 is a flowchart representing an example method for connecting a mobile communication device to a conference call;

FIG. 10 is a flowchart representing an example method for determining whether the user's input indicates to delay connecting to the conference call; and

FIG. 11 is a flowchart representing an example method for indicating status of conference call participants on a mobile communication device.

### DESCRIPTION OF EXAMPLE EMBODIMENTS

The embodiments described herein provide methods and systems for connecting a mobile communication device to a conference call. In some embodiments, the methods and systems described herein can display a message associated with a received first request from a network server for connecting to a conference call. The methods and systems described herein can also receive a delay option selection; and display, based on the received delay option selection, a plurality of delay-time options. Each of the plurality of delay-time options can provide a delay time for establishing a connection to the conference call. The methods and systems described herein can further receive a selection of one of the plurality of delay-time options associated with a time for establishing a connection to the conference call.

The following detailed description refers to the accompanying drawings. Wherever possible, the same reference numbers are used in the drawings and the following description to refer to the same or similar parts. While several example embodiments are described herein, modifications, adaptations, and other implementations are possible. For example, substitutions, additions, or modifications can be made to the components illustrated in the drawings, and the example methods described herein can be modified by substituting, reordering, or adding steps to the disclosed methods. Accordingly, the foregoing general description and the following detailed description are example and explanatory only and are not limiting. Instead, the proper scope is defined by the appended claims.

In addition, numerous specific details are set forth in order to provide a thorough understanding of the example embodiments described herein. It will be appreciated, however, that the example embodiments described herein can be practiced without these specific details. Furthermore, well-known methods, procedures and components have not been described in detail so as not to obscure the example embodiments described herein.

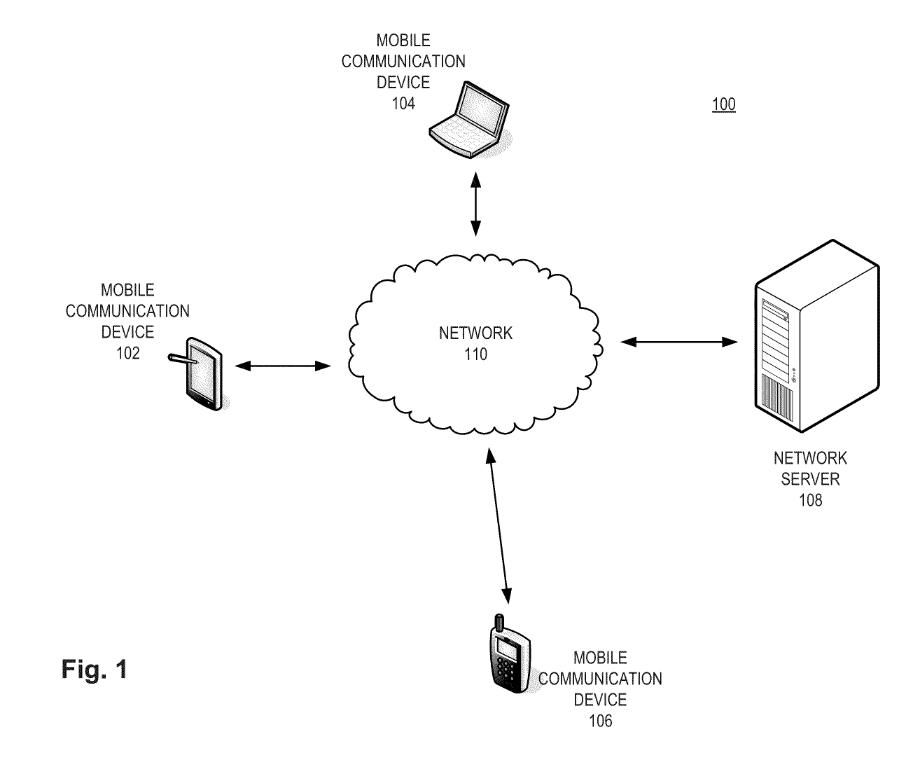

FIG. 1 is a block diagram of an example network environment 100. Network environment 100 can include one or more mobile communication devices (e.g., 102, 104, and 106), a network server 108, and a network 110. In some instances, one or more of the mobile communication devices 102, 104, and 106 can be devices that are referred to as “delaying participant's devices” or “delaying devices” or “snoozing devices.” In some other instances, one or more of the mobile communication devices 102, 104, and 106 can also be devices that are referred to as a “receiving participant's devices” or “receiving mobile communication device” or “receiving devices.” Details of the types of devices will be described below. For illustration purposes, mobile communication device 102 is hereinafter referred as “delaying participant's devices” or “delaying devices” or “snoozing devices.” And mobile communication device 106 is hereinafter referred to as “receiving participant's devices” or “receiving mobile communication device” or “receiving devices.”

Mobile communication devices 102, 104, and 106 can include devices equipped with communications modules for cellular communication, devices equipped for Wi-Fi data communications, or dual-mode devices capable of both cellular and Wi-Fi data communications. As examples, mobile communication devices 102, 104, and 106 can be handheld devices, multiple-mode communication devices configured for both data and voice communication, smartphones, mobile telephones, netbooks, gaming consoles, tablets, or personal digital assistants (PDAs) enabled for wireless communication. Details of an example mobile communication device will be described below.

Network server 108 can be a server that can communicate, such as establishing conference calls, with mobile communication devices 102, 104, and 106. As an example, network server 108 can automatically request connections, such as by initiating conference calls, to mobile communication devices 102, 104, and 106 at a scheduled conference time. Network server 108 can communicate with mobile communication devices 102, 104, and 106 via various manners. For example, in some embodiments, network server 108 (e.g., a conference call server) can communicate via circuit-switched calls (e.g., Public Switched Telephone Network calls or PSTN calls). In some embodiments, network server 108 (e.g., an instant messenger (IM) server) can communicate via Voice over Internet Protocol (VoIP) calls.

Moreover, network server 108 can also communicate via both PSTN calls and VoIP calls. In some embodiments, network server 108 can automatically determine the manner of communication. As an example, network server 108 can determine whether a mobile communicate device (e.g., mobile communication device 102) is in a service area of a cellular network, and connect to the mobile communicate device if it is in the service area. If the mobile communication device is not in the service area, network server 108 can determine whether the mobile communication device is connected to a data network, such as the Internet. For example, network server 108 can determine that the mobile communication device is connected to the Internet because the Instant Messaging (IM) service of the mobile communication device indicates that the user is “online.” Example IM services include .NET Messenger Service, AOL® Instant Messenger™ (AIM), Excite® Pal, Gadu-Gadu, Google Talk™, iChat®, ICQ®, Jabber®, Qnext™, QQ®, Skype® and Yahoo!® Messenger. If the network server 108 determines that the mobile communication device is connected to a data network, it can communicate with the mobile communicate device via, for example, a VoIP call at the scheduled conference time.

In some embodiments, network server 108 can also communicate with the user's mobile communication device via either PSTN calls or VoIP calls based on the user's preference. For example, a user could be travelling outside of his or her home service area and thus a PSTN call can be very expensive due to roaming charges. Therefore, the user could prefer to receive VoIP calls while he is travelling. Network server 108 can then communicate to the user's mobile communication device via only VoIP calls regardless of whether the user's mobile communication device is in a service area of a cellular network. Network server 108 is further described in application Ser. No. ______ (Attorney Docket No. 11298.0437-00000), which is hereby incorporated by reference in its entirety.

Network 110 can be operatively coupled to one or more mobile communication devices 102, 104, and 106, to enable communication and exchange of data and/or voice with network server 108. Network 110 can be any type of network capable of transmitting data and/or voice, such as the Internet, or any other type of LAN, WAN, or cellular network (e.g., 3GPP, 3GPP2, 4G, LTE). In some embodiments, network 110 can be omitted and the mobile communication devices 102, 104, and 106 can communicate using any wired or wireless direct communication technology, such as via a Bluetooth connection.

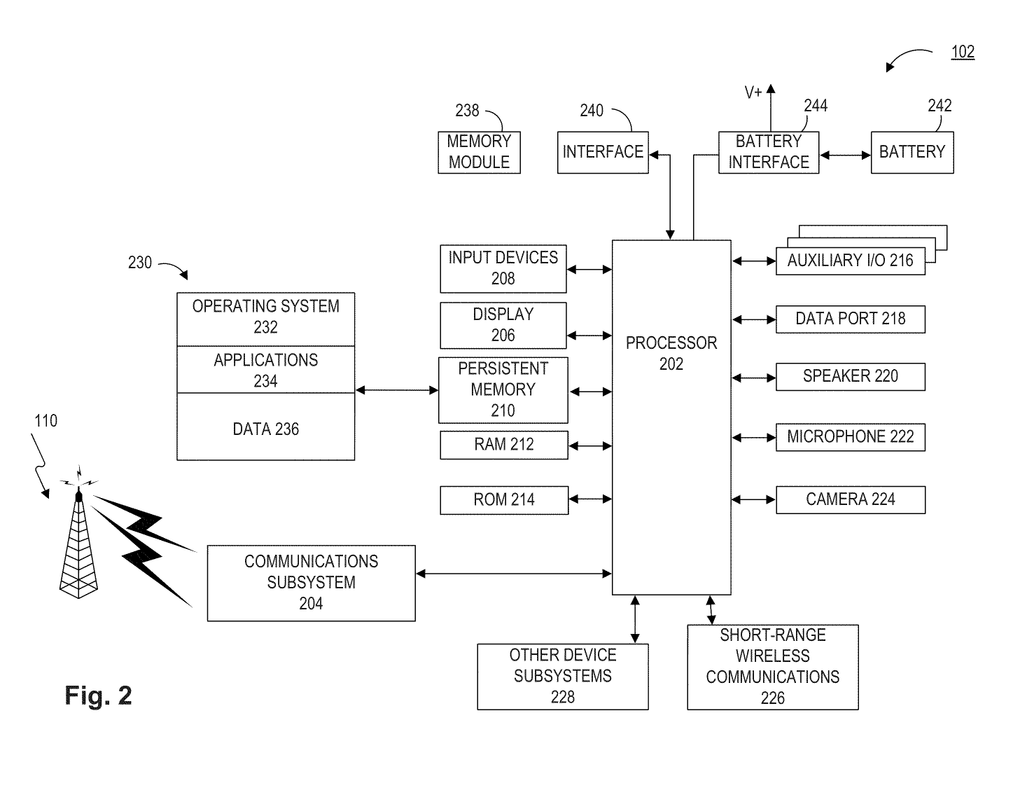

FIG. 2 is a simplified block diagram illustrating an example mobile communication device 102. Note that while FIG. 2 is described in reference to mobile communication device 102, it also applies to mobile communication devices 104 and 106. Accordingly, any reference to mobile communication device 102 is equally applicable to mobile communication devices 104 and 106, unless otherwise indicated.

Mobile communication device 102 can include a communication device having two-way or one-to-many data communication capabilities, voice communication capabilities, and video communication capabilities, and the capability to communicate with other computer systems, for example, via the Internet. Depending on the functionality provided by mobile communication device 102, in various embodiments, mobile communication device 102 can be a handheld device, a multiple-mode communication device configured for both data and voice communication, a smartphone, a mobile telephone, a netbook, a gaming console, a tablet, or a PDA enabled for wireless communication.

Mobile communication device 102 can include a case (not shown) housing component of mobile communication device 102. The internal components of mobile communication device 102 can, for example, be constructed on a printed circuit board (PCB). The description of mobile communication device 102 herein mentions a number of specific components and subsystems. Although these components and subsystems can be realized as discrete elements, the functions of the components and subsystems can also be realized by integrating, combining, or packaging one or more elements in any suitable fashion.

Mobile communication device 102 can include a controller comprising at least one processor 202 (such as a microprocessor), which controls the overall operation of mobile communication device 102. Processor 202 can be one or more microprocessors, field programmable gate arrays (FPGAs), digital signal processors (DSPs), or any combination thereof capable of executing particular sets of instructions. Processor 202 can interact with device subsystems such as a communication subsystem 204 for exchanging radio frequency signals with a wireless network (e.g., network 110) to perform communication functions.

Processor 202 can also interact with additional device subsystems including a communication subsystem 204, a display 206 such as a liquid crystal display (LCD) screen or any other appropriate display, input devices 208 such as a keyboard and control buttons, a persistent memory 210, a random access memory (RAM) 212, a read only memory (ROM) 214, auxiliary input/output (I/O) subsystems 216, a data port 218 such as a conventional serial data port, a Universal Serial Bus (USB) data port, or a High-Definition Multimedia Interface (HDMI) data port, a speaker 220, a microphone 222, one or more cameras (such as camera 224), a short-range wireless communications subsystem 226 (which can employ any appropriate wireless (e.g., RF), optical, or other short range communications technology (for example, Bluetooth or NFC)), and other device subsystems generally designated as 228. Some of the subsystems shown in FIG. 2 perform communication-related functions, whereas other subsystems can provide “resident” or on-device functions.

Communication subsystem 204 includes one or more communication systems for communicating with network 110 to enable communication with external device, such as mobile communication devices 104 and 106, and network server 108. The particular design of communication subsystem 204 depends on the wireless network in which mobile communication device 102 is intended to operate. Mobile communication device 102 can send and receive communication signals over the wireless network after the required network registration or activation procedures have been completed.

Display 206 can be realized as a touch-screen display in some embodiments. The touch-screen display can be constructed using a touch-sensitive input surface, which is coupled to an electronic controller and which overlays the visible element of display 206. The touch-sensitive overlay and the electronic controller provide a touch-sensitive input device and processor 202 interacts with the touch-sensitive overlay via the electronic controller.

Camera 224 can be a CMOS camera, a CCD camera, or any other type of camera capable of capturing and outputting compressed or uncompressed image data such as still images or video image data. In some embodiments mobile communication device 102 can include more than one camera, allowing the user to switch, during a video conference call, from one camera to another, or to overlay image data captured by one camera on top of image data captured by another camera. Image data output from camera 224 can be stored in, for example, an image buffer, which can be a temporary buffer residing in RAM 212, or a permanent buffer residing in ROM 214 or persistent memory 210. The image buffer can be, for example, a first-in first-out (FIFO) buffer.

Short-range wireless communications subsystem 226 is an additional optional component that provides for communication between mobile communication device 102 and different systems or devices, which need not necessarily be similar devices. For example, short-range wireless communications subsystem 226 can include an infrared device and associated circuits and components, or a wireless bus protocol compliant communication device such as a Bluetooth® communication module to provide for communication with similarly-enabled systems and devices.

Processor 202 can be one or more processors that operate under stored program control and executes software modules 230 stored in a tangibly-embodied nontransitory computer-readable storage medium such as persistent memory 210, which can be a flexible disk, a hard disk, a CD-ROM (compact disk-read only memory), and MO (magneto-optical); a DVD-ROM (digital versatile disk-read only memory); a DVD RAM (digital versatile disk-random access memory); or a semiconductor memory. Software modules 230 can also be stored in a computer-readable storage medium such as ROM 214, or any appropriate persistent memory technology, including EEPROM, EAROM, FLASH. These computer-readable storage mediums store computer-readable instructions for execution by processor 202 to perform a variety of functions on mobile communication device 102.

Software modules 230 can include operating system software 232, used to control operation of mobile communication device 102. Additionally, software modules 230 can include software applications 234 for providing additional functionality to mobile communication device 102. For example, mobile communication device 102 can include a calendar application for allowing a user to schedule and establish appointments, such as video conference appointments, and a video conference application designed to assist a user with performing video conferences.

Software applications 234 can include a range of applications, including, for example, an e-mail messaging application, an address book, a notepad application, an Internet browser application, a voice communication (i.e., telephony or Voice over Internet Protocol (VoIP)) application, a mapping application, a media player application, or any combination thereof. Each of software applications 234 can include layout information defining the placement of particular fields and graphic elements (for example, text fields, input fields, icons, etc.) in the user interface (i.e., display 206) according to that corresponding application.

Operating system software 232 can provide a number of application protocol interfaces (APIs) providing an interface for communicating between the various subsystems and services of mobile communication device 102, and software applications 234. For example, operating system software 232 provides a user interface API to any application that needs to create user interfaces for display on mobile communication device 102. Accessing the user interface API can provide the application with the functionality to create and manage screen windows and user interface controls, such as text boxes, buttons, and scrollbars; receive mouse and keyboard input; and other functionality intended for display on display 206. Furthermore, a camera service API can allow a video conference application to access camera 224 for purposes of capturing image data (such as a photo or video data that can be shared with a receiving mobile communication device (e.g., mobile communication device 106)).

In some embodiments, persistent memory 210 stores data 236, including data specific to a user of mobile communication device 102, such as video conference profiles for indicating one or more preferences relevant for video conferencing. Persistent memory 210 can additionally store identification data, such as identifiers related to particular conferences, or an identifier corresponding to mobile communication device 102 to be used in identifying mobile communication device 102 during conferences. Persistent memory 210 can also store data relating to various people, for example, a name of a user, a user's identifier (user name, email address, phone number, or any other identifier), place of employment, work phone number, home address, or other types of user-specific information. Persistent memory 210 can further store data relating various applications with preferences of the particular user of, for example, mobile communication device 102. In certain embodiments, persistent memory 210 can store data 236 linking a user's data with a particular field of data in an application, such as for automatically entering a user's name into a username textbox on an application executing on mobile communication device 102. Furthermore, in various embodiments, data 236 can also include service data comprising information required by mobile communication device 102 to establish and maintain communication with network 110.

In some embodiments, auxiliary input/output (I/O) subsystems 216 comprise an external communication link or interface, for example, an Ethernet connection. In some embodiments, auxiliary I/O subsystems 216 can further comprise one or more input devices, including a pointing or navigational tool such as a clickable trackball or scroll wheel or thumbwheel; or one or more output devices, including a mechanical transducer such as a vibrator for providing vibratory notifications in response to various events on mobile communication device 102 (for example, receipt of an electronic message or incoming phone call), or for other purposes such as haptic feedback (touch feedback); or any combination thereof.

In some embodiments, mobile communication device 102 also includes one or more removable memory modules 238 (typically comprising FLASH memory) and a memory module interface 240. Among possible functions of removable memory module 238 is to store information used to identify or authenticate a user or the user's account to a wireless network (for example, network 110). For example, in conjunction with certain types of wireless networks, including GSM and successor networks, removable memory module 238 is referred to as a Subscriber Identity Module (SIM). Memory module 238 is inserted in or coupled to memory module interface 240 of mobile communication device 102 in order to operate in conjunction with the wireless network.

Mobile communication device 102 also includes a battery 242, which furnishes energy for operating mobile communication device 102. Battery 242 can be coupled to the electrical circuitry of mobile communication device 102 through a battery interface 244, which can manage such functions as charging battery 242 from an external power source (not shown) and the distribution of energy to various loads within or coupled to mobile communication device 102.

A set of applications that control basic device operations, including data and possibly voice communication applications, can be installed on mobile communication device 102 during or after manufacture. Additional applications or upgrades to operating system software 232 or software applications 234 can also be loaded onto mobile communication device 102 through the wireless network (for example network 110), auxiliary I/O subsystem 216, data port 218, short-range wireless communication subsystem 226, or other suitable subsystem such as 228. The downloaded programs or code modules can be permanently installed, for example, written into the persistent memory 210, or written into and executed from RAM 212 for execution by processor 202 at runtime.

Mobile communication device 102 can provide three principal modes of communication: a data communication mode, a voice communication mode, and a video communication mode. In the data communication mode, a received data signal such as a text message, an e-mail message, Web page download, VoIP data, or an image file are processed by communication subsystem 204 and input to processor 202 for further processing. For example, a downloaded Web page can be further processed by a browser application, or an e-mail message can be processed by an e-mail message messaging application and output to display 206. A user of mobile communication device 102 can also compose data items, such as e-mail messages, for example, using the input devices, such as auxiliary I/O subsystem 216, in conjunction with display 206. These composed items can be transmitted through communication subsystem 204 over the wireless network (for example network 110). In the voice communication mode, mobile communication device 102 provides telephony functions and operates as a typical cellular phone. In the video communication mode, mobile communication device 102 provides video telephony functions and operates as a video teleconference terminal. In the video communication mode, mobile communication device 102 utilizes one or more cameras (such as camera 224) to capture video for the video teleconference.

As indicated above, persistent memory 210 can store software applications 234, each of which providing functionality for mobile communication device 102. For example, a video conference application provides a user of mobile communication device 102 with the ability to coordinate video conferences with others users, such as a user of mobile device 106. The video conference includes the transmission of video image data captured via camera 224, enabling users to view live pictures of one another. In another embodiment, the video conference application provides the capability of sending screen image data during a screen sharing session between the devices. That is, the video conference application can provide capabilities such that screen image data depicting the screen of mobile communication device 102 can be displayed on one or more of, for example, mobile communication devices 104 and 106 or a plurality of additional computing devices in a single sharing session or a multicast sharing session. The video conference application can also exchange live video images or screen image data with network server 108. The video conference application can provide a user of mobile communication device 102 with the ability to switch between transmission of live video images, and transmission of image data of a shared screen.

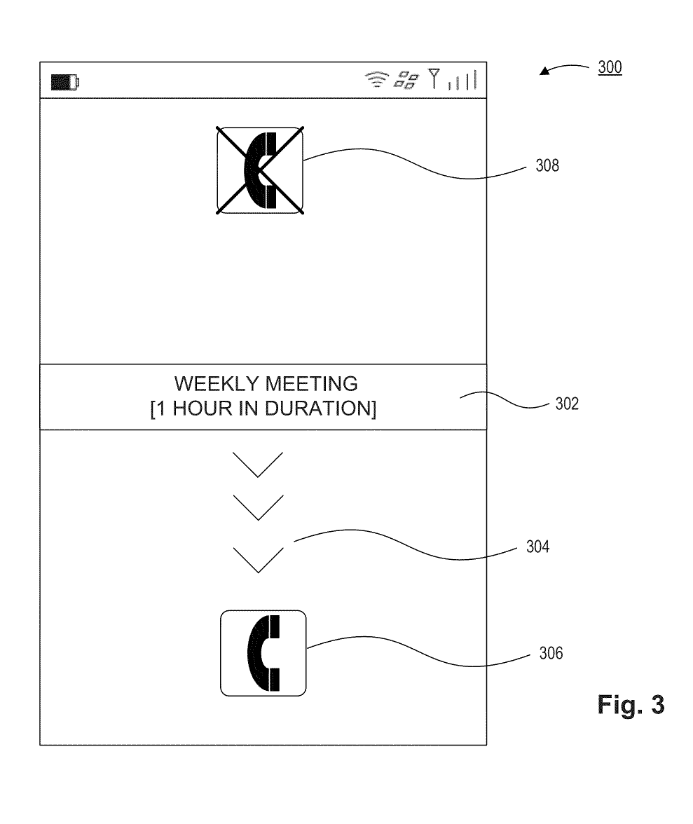

FIG. 3 illustrates an example graphical user interface 300 provided, such as displayed, on a mobile communication device (e.g., mobile communication device 102) after receiving a first request from a network server (e.g. network server 108) for connecting to a conference call. Interface 300 can be accessed from the desktop of a mobile communication device (e.g., mobile communication device 102), for example in response to a message or a command received from communication subsystem 204 to execute a conference application. In some embodiments, interface 300 can be accessed via physical key or button on the mobile communication device.

After receiving the first request from the network server for connecting to a conference call, the mobile communication device can provide, such as display via interface 300, a message 302 corresponding to the first request, an animation 304, a connection icon 306, and a dismiss icon 308. Message 302 can indicate that the mobile communication device is receiving the first request, such as a PSTN call or a VoIP call, from a network server for connecting to the conference call at the scheduled conference time. For example, after receiving the first request at the scheduled conference time, message 302 can show that it is time for the weekly meeting and the meeting duration is 1 hour. Interface 300 can display message 302, for example, in a banner, an alert, a pop-up window, or in any other manner.

In some embodiments, for responding to the first request, the mobile communication device can receive an input moving message 302 in different directions, such as vertically or horizontally, on interface 300. For example, message 302 can be moved based on the user touching, sliding, swiping, or any other moving of message 302. In some embodiments, message 302 itself cannot be moved, but interface 300 can provide a button (not shown), which a user can touch, slide, swipe, or otherwise move to respond to the first request. Movement of message 302 and selection of the button will be further described below.

Animation 304 can provide indication or suggestion of, for example, the direction that message 302 can be moved so as to respond to the first request. As an example, animation 304 can be downward arrows displayed in sequence on interface 300, and thus provide indication that moving message 302 downward can, for example, connect to the conference call. Correspondingly, connection icon 306 (e.g., a green phone icon) indicates that the connection to the conference call can be established by moving message 302 toward it. Similarly, dismiss icon 308 (e.g., a red phone icon) indicates that the first request for connecting to the conference call can be declined or dismissed by moving message 302 toward it. In some embodiments, an animation (not shown) can be provided to show the direction that the message 302 should be moved to in order to decline the conference call.

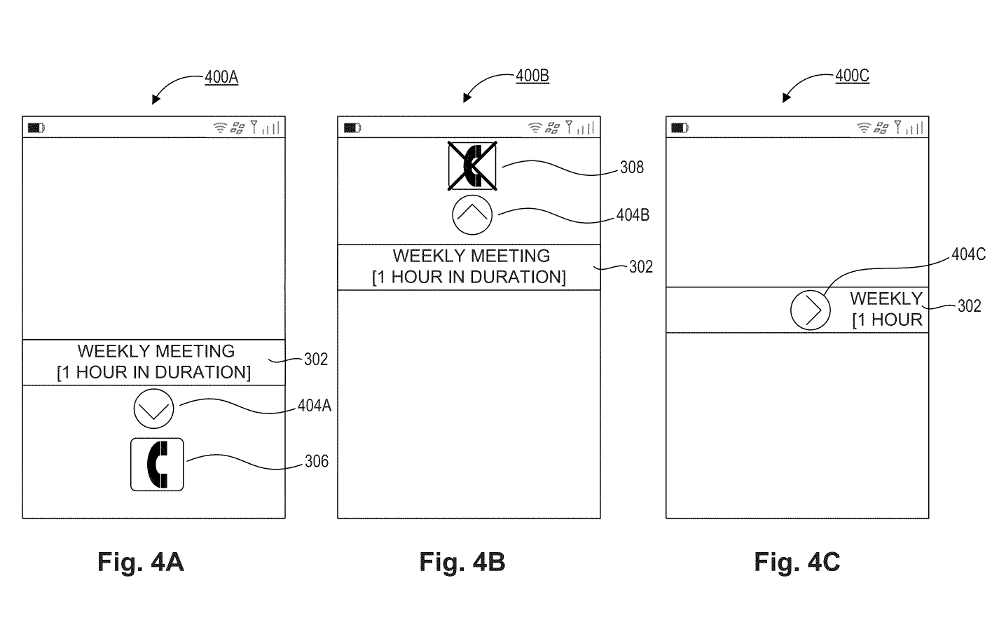

FIGS. 4A-4C illustrate example graphical user interfaces 400A-C provided, such as displayed, on a mobile communication device (e.g., mobile communication device 102) corresponding to the user's responses to the first request for connecting to the conference call. Interfaces 400A-C can be accessed from the desktop of a mobile communication device (e.g., mobile communication device 102), for example in response to a command from auxiliary I/O subsystem 216 for responding to the first request. In some embodiments, interfaces 400A-C can be accessed via physical key or button on the mobile communication device.

As shown in FIG. 4A, interface 400A can display message 302, an animation 404A, and first icon 306. As described above, after receiving the first request from a network server (e.g. network server 108) for connecting to a conference call, the mobile communication device (e.g., mobile communication device 102) can provide, such as display via interface 300, message 302 corresponding to the first request for connecting to a conference call at the scheduled conference time. The mobile communication device can receive an input selecting the response to the first request. For example, the mobile communication device can receive an input to connect to the conference call and therefore move message 302 downward toward connection icon 306 to connect to the conference call. Interface 400A can display that message 302 is being moved downward toward connection icon 306. In some embodiments, animation 404A (e.g., downward arrows displayed in sequence) can be shown on interface 400A to indicate the direction of the movement of message 302. In some other embodiments, animation 404A is not displayed.

As shown in FIG. 4B, the mobile communication device can receive an input to decline the first request for connecting to the conference call. For example, the input can be moving message 302 upward toward dismiss icon 308. Correspondingly, interface 400B can also display that message 302 is being moved upward toward dismiss icon 308. In some embodiments, animation 404B (e.g., upward arrows displayed in sequence) can be shown on interface 400B to indicate the direction of the movement of message 302. In some other embodiments, animation 404B is not displayed.

As shown in FIG. 4C, the mobile communication device can receive an input to delay connecting to the conference call. For example, the input can be moving message 302 horizontally. Correspondingly, interface 400C can display that message 302 is being moved horizontally. It can be appreciated that message 302 can be moved horizontally either to the right or to the left. In some embodiments, animation 404C (e.g., horizontal arrows displayed in sequence) can be shown on interface 400C to indicate the direction of the movement of message 302. In some other embodiments, animation 404C is not displayed.

The mobile communication device can detect the input of the user. As described above, the input of the user can be indicated by the direction of message 302 being moved on interfaces 400A-C. For instance, when message 302 is being moved downward toward connection icon 306 or upward toward dismiss icon 308, the mobile communication device can detect via, for example, auxiliary I/O subsystem 216, the corresponding direction of the movement.

Based on the detection, the mobile communication device can determine whether a delay for connecting to the conference call has been selected. For example, if the mobile communication device detects a downward movement or an upward movement, it can determine that the user's input indicates to either connect to the conference call or dismiss the first request for connecting to the conference call, respectively. If the mobile communication device detects a horizontal movement, for example, it can determine that the user's input indicates to delay connecting to the conference call. It can be appreciated that the mobile communication device can detect any type of movement to any direction. And the mobile communication device can determine, based on the detection, whether the received input indicates to delay connecting to the conference call.

As described above, in some embodiments, message 302 itself is not moved, but an interface (e.g., interface 300) of the mobile communication device can provide a button (not shown), which a user can touch, slide, or otherwise move to respond to the first request for connecting to a conference call. In some embodiments, after the user touches, slides, or otherwise moves the button, the mobile communication device can provide an interface (not shown) providing, such as displaying, a plurality of request responding buttons. The request responding buttons can include a plurality of responding options. The request responding buttons can include, for example, a first button for connecting to the conference call, a second button for dismissing the first request, and a third button for delaying the connection to the conference call. The plurality of request responding buttons can be displayed, for example, by using different colors or shapes. The mobile communication device can receive a selection for performing the desired responding action. For example, the mobile communication device can detect the user touching the first button to connect to the conference call, the second button to dismiss the first request, or the third button to delay connecting to the conference call. It is appreciated that the mobile communication device can provide any interface that displays any type of control functions for the user to respond to the first request to connect to a conference call. In some embodiments, a mobile communication device can also provide interface and/or control functions for determining whether to delay the connection to the conference call, by, for example, a calendar function included in software applications 234 or from the network server. The providing interface and/or control functions by a calendar function will be further described below.

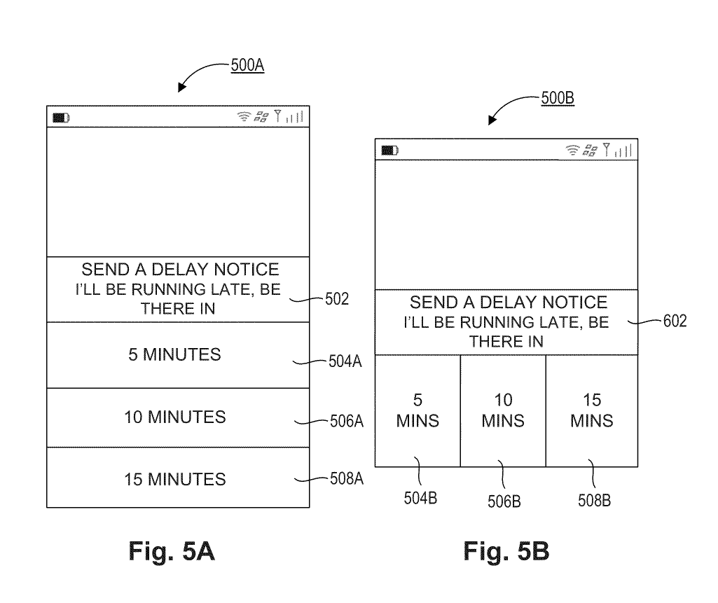

FIGS. 5A-5B illustrate example graphical user interfaces 500A-B provided, such as displayed, on a mobile communication device when the mobile communication device receives a delay option selection, such as an input for delaying the connection to the conference call. Interfaces 500A-B can be accessed from the desktop of a mobile communication device (e.g., mobile communication device 102), for example in response to a command from auxiliary I/O subsystem 216. In some embodiments, interfaces 500A-B can be accessed via physical key or button on the mobile communication device.

After receiving the delay option selection, the mobile communication device can provide, via interfaces 500A-B, a plurality of delay-time options for delaying the connection to the conference call. Each of the plurality of delay-time options can provide a delay time for establishing a connection to the conference call. As shown in FIGS. 5A-5B, the mobile communication device can display the plurality of delay-time options for connecting to the conference call as a plurality of delay-time buttons arranged vertically (e.g., buttons 504A, 506A, and 508A) or horizontally (e.g., buttons 504B, 506B, and 508B). The plurality of delay-time buttons can enable different delay times for connecting to the conference call. For example, delay-time buttons 504A-B can enable delay for 5 minutes; delay-time buttons 506A-B can enable delay for 10 minutes; and delay-time buttons 508A-B can enable delay for 15 minutes. It is appreciated that the delay time is not limited to 5, 10, and 15 minutes, and can be any time period that is desired. In some embodiments, a message 502 (e.g. a message showing “SEND A DELAY NOTICE, I'll be running late, be there in”) can also be displayed on interfaces 500A-B.

After the mobile communication device provides the plurality of delay-time options, the user of the mobile communication device can select the desired delay-time option by, for example, touching one of the delay-time buttons 504A-B, 506A-B, and 508A-B. After receiving the selection, the mobile communication device can send a delay notice corresponding to the selected delay-time option to the network server. For example, if the mobile communications device receives delay-option selection that enables a 10-minutes delay to connect to the conference call, the mobile communication device can send a delay notice to notify the network server (e.g. network server 108) that the user wishes to delay for 10 minutes. In some embodiments, the mobile communication device can also dismiss the first request (e.g., a PSTN call or a VoIP call) after the delay notice is sent to the network server. In some embodiments, if the user changes his or her mind and no longer wishes to delay connecting to the conference call, the mobile communication device can provide a control function (e.g., a go-back or cancel button, not shown) displayed on interfaces 500A-B, such that the mobile communication device can send a request to connect to the conference call or to dismiss the first request for connecting to the conference call, as described above.

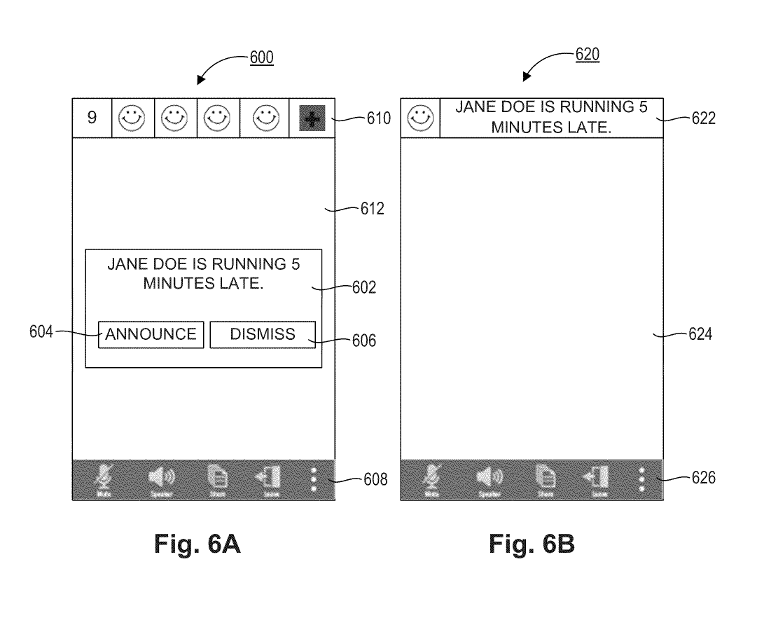

FIGS. 6A-6B illustrate example graphical user interfaces 600 and 620 provided, such as displayed, on a receiving mobile communication device (e.g., mobile communication device 106) for receiving a delay notification from the network server. Interfaces 600 and 620 can be accessed from the desktop of the receiving mobile communication device, for example in response to a command from auxiliary I/O subsystem 216.

As described above, in responding to the first request from a network server (e.g., network server 108) for connecting to a conference call at a scheduled conference time, a mobile communication device (e.g., mobile communication device 102) can send a delay notice corresponding to a selected delay option to the network server. The mobile communication device that sends out the delay notice can be referred to as a snoozing device. After the network server receives the delay notice, it can provide a delay notification to one or more of the conference participants. As an example, in some embodiments, the network server can transmit a delay notification to the receiving mobile communication device of the host of the conference call, indicating that the user of the snoozing device is delaying to connect to the conference call. In some embodiments, the network server can transmit a delay notification to one or more receiving mobile communication devices of all conference call participants, notifying them that the user of the snoozing device is delaying to connect to the conference call. The delay notification provided by the network server can include, for example, the identity of a conference call participant that is delaying to connect to the conference call and a delay time. The identity of the conference call participant can be the participant's name, user name, phone number, group name, group identifier, teleconference room, branch office, organization, etc. The conference call participant that is delaying to connect to the conference call is also referred to as a delaying conference call participant or a snoozer. As an example, a delay notification can include the name of the delaying conference call participant (e.g., Jane Doe), and a 10 minutes delay time, which indicates that the delaying conference call participant is delaying for 10 minutes to connect to the conference call.

After a receiving mobile communication device (e.g. mobile communication device 106) receives a delay notification from a network server, the receiving mobile communication device can provide notifications such as real-time notifications or persistent notifications. As shown in FIG. 6A, in some embodiments, the receiving mobile communication device, via interfaces 600, can provide a real-time notification. Interface 600 can include a message 602, an announce button 604, a dismiss button 606, a control area 608, a conference participants banner 610, and a working area 612. Interface 600 can be displayed, for example, on a receiving mobile communication device of the host of the conference call. In some embodiments, the host of the conference call is the moderator of the conference call.

As shown in FIG. 6A, message 602 can indicate that the delaying conference call participant (e.g., Jane Doe) is delaying to connect to the conference call. In some embodiments, message 602 can also indicate the delay time. For example, message 602 can show that “Jane Doe is running 5 minutes late.” Message 602 can be displayed in a dialogue or pop-up window, or in any manner anywhere on interface 600. In some embodiments, the dialogue or pop-up window that includes message 602 can also include announce button 604 and dismiss button 606. After message 602 is displayed on interface 600, the mobile communication device can receive a selection to one of announce button 604 and dismiss button 606. As an example, if the receiving mobile communication device is designated as being associated with the host of the conference call, the selection of announce button 604 can notify the other conference call participants that the delaying conference call participant is delaying to connect to the conference call. In some embodiments, after the selection of announce button 604, the receiving mobile communication device can, for example, request the network server to notify other conference call participants about the delaying conference call participant's delay. In some embodiments, the host's receiving mobile communication device can directly notify the other conference call participants about the delaying conference call participant's delay without the use of announce button 604. In some embodiments, message 602 does not include announce button 604.

As another example, the receiving mobile communication device can receive input selection dismiss button 606 for dismissing message 602. After dismiss button 606 is selected, interface 600 can dismiss message 602, can minimize message 602, or can hide message 602 in the background. Interface 600 can also include control area 608, which can include a plurality of control functions, such as a mute function, a speaker function, a share function, or a menu providing other control functions, such as a function for displaying message 602. The control functions can enable a conference call participant to control the participating of the conference call in a desired manner. As an example, the control functions can enable a conference call participant to select the mute function to mute the microphone (e.g., microphone 222) of the mobile communication device.

Interface 600 can also include conference participants banner 610, which can provide identifies representing the conference participants that are present in the conference. As an example, conference participants banner 610 can be displayed in the navigation bar area (e.g., top area of interface 600). The identifies representing the conference participants can be names, icons, or thumbnail photos of the conference call participants that are currently present in the conference call. If the number of identifies representing the conference participants exceeds the number that can be displayed in conference participants banner 610, conference participants banner 610 can also include an expansion icon (e.g., a “+” icon) to enable the rest of the identifiers to be displayed. Conference participants banner 610 can also provide total number of conference call participants that are currently present in the conference call.

Working area 612 can display contents or subject matters that are discussed or shared in the conference call. For example, working area 612 can allow a conference participant to create a drawing and share it with the other conference participants. In some embodiments, working area 612 can become inactive (e.g., by not responding to a user's touch in working area 612) while message 602 is displayed on interface 600. Thus, the mobile communication device can direct a user's attention to message 602. Working area 612 can become active again after, for example, the user dismisses message 602 by selecting dismiss button 606.

As shown in FIG. 6B, the receiving mobile communication device, via interface 620, can also provide a different type of real-time notification. Interface 620 can include a notification banner 622, a working area 624, and a control area 626. Interface 620 can be displayed, for example, on a receiving mobile communication device of a conference call participant. In some embodiments, notification banner 622 (e.g., a toast displayed at the top of interface 620) can display a message indicating that the delaying conference call participant is delaying to connect to the conference call. For example, the message can show that “Jane Doe is running 5 minutes late.” Notification banner 622 can also include an icon or a thumbnail photo of the delaying conference call participant. Working area 624 and control area 626 can be the same or similar to working area 612 and control area 608, respectively, and thus will not be described here.

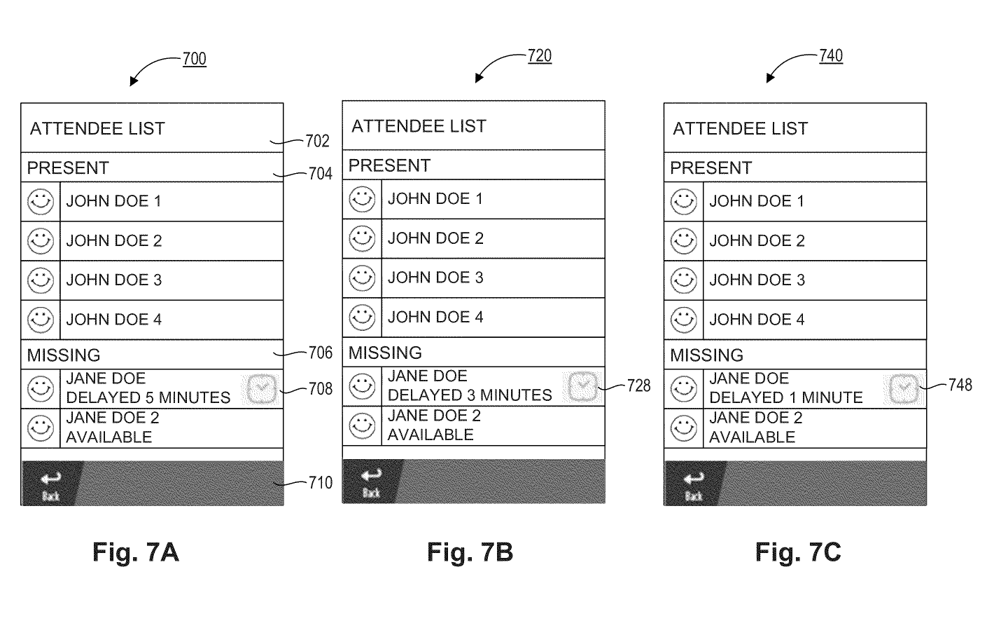

FIGS. 7A-7C illustrates example graphical user interfaces 700, 720, and 740 displayed on a receiving mobile communication device (e.g., mobile communication device 106) for providing an attendee list 702 of the conference call. The attendee list can include present participant list 704 and missing participant list 706. Present participant list 704 includes a list of conference call participants that are currently present in the conference call. Missing participant list 706 includes a list of conference call participant that are currently missing from conference call. For example, missing participant list 706 can include delaying conference call participants (e.g., Jane Doe as show in FIG. 7A). For those missing participants, graphical user interfaces 700, 720, and 740 can provide a status indicator 708, which can include a delay notification and updates of the remaining delay time from the network server (e.g., network server 108). Interfaces 700, 720, and 740 can be accessed from the desktop of a mobile communication device, for example in response to a command from auxiliary I/O subsystem 216.

As described above, a receiving mobile communication device can receive a delay notification from a network server. After the delay notification is received, the receiving mobile communication device can provide notifications such as real-time notifications or persistent notifications. As shown in FIG. 7A, in some embodiments, the receiving mobile communication device, via interface 700, can provide a persistent notification. A persistent notification can be provided by, for example, displaying a status indicator 708 representing the status of the delaying conference call participant. In some embodiments, status indicator 708 can be displayed along with the identity of the delaying conference call participant (e.g., Jane Doe) in attendee list 702. Status indicator 708 can include a delay time, which indicates the delaying time for the delaying conference call participant to connect to the conference call. The delay time can be displayed, for example, in a short message such as a message showing “Delayed 5 Minutes” and/or a clock icon representing the delay time. In some embodiments, the clock icon can be animated to indicate that a delaying conference call participant is delaying 10 minutes to connect to the conference call.

Interfaces 700, 720, and 740 can include a control area 710. Control area 710 can include one or more control functions that enable the user of the mobile communication device to navigate or otherwise control interface 700. For example, control area 710 can include a control function that allows the user to navigate away from interface 700 to go back to a previous interface.

In some embodiments, in addition to providing the delay notification, the network server can also provide updates of the remaining delay time. As described above, after receiving a delay notice from a snoozing device (e.g., mobile communication device 102), the network server can provide a delay notification to one or more receiving mobile communication devices (e.g., mobile communication device 106). The delay notification can include a delay time of, e.g., 5 minutes. As time passes by, the network server can also provide updates of the remaining delay time, e.g., 3 minutes, 1 minute, and so forth, to the receiving mobile communication devices. The updates can be provided, for example, in one or more updating notifications. In some embodiments, after receiving the delay notification, the one or more receiving mobile communication devices can provide updates of the remaining delay time independent of the network server.

After the receiving mobile communication device receives the updates of the remaining delay time, the remaining delay time can be displayed. As shown in FIGS. 7B and 7C, a receiving mobile communication device can display, via interfaces 720 and 740, updated status indicators corresponding to the updates of the remaining delay time. That is, the receiving mobile communication device can include a count-down function in the status indicator. For example, interface 720 can display an updated status indicator 728, indicating that the remaining delay time is 3 minutes; and interface 740 can display another updated status indicator 748, indicating that the remaining delay time is 1 minute. It is appreciated that the 3 minutes and 1 minute remaining delay time are for illustration purpose only and interfaces 720 and 740 can display status indictors corresponding to updates of any remaining delay time.

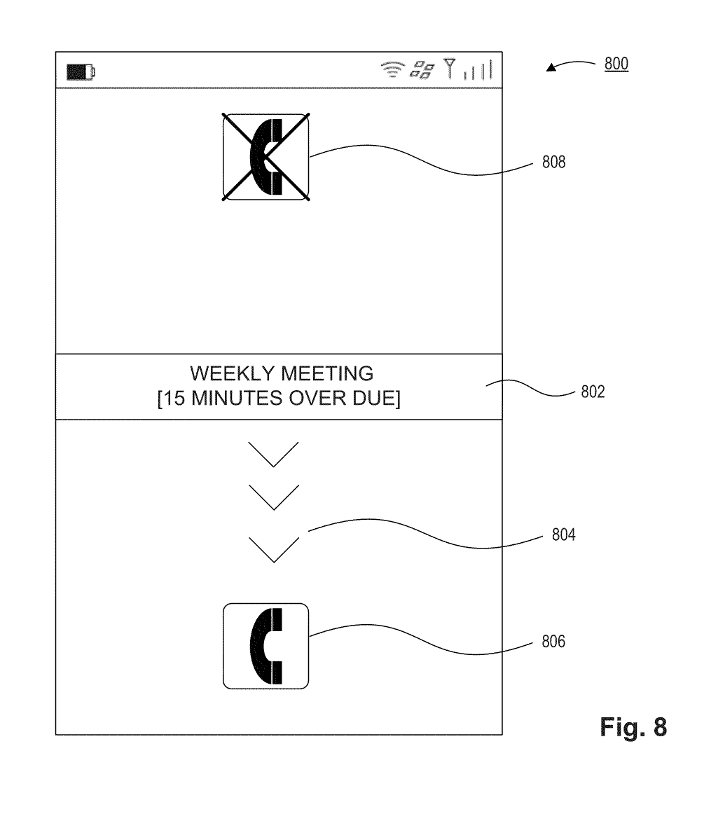

FIG. 8 illustrates an example graphical user interface 800 provided, such as displayed, on a snoozing device (e.g., mobile communication device 102) after receiving a second request from a network server (e.g., network server 108) for connecting to a conference call after the delay time elapses. As described above, after a mobile communication device sends a delay notice (and thus becomes a snoozing device) to the network server, it can dismiss the first request (e.g., a PSTN call or a VoIP call) for connecting to the conference call and becomes a snoozing device. The delay notice can include a delay time for connecting to the conference call. After the delay time elapses, the network server can then send a second request to the snoozing device for connecting to the conference call. As an example, if the delay time is 15 minutes, the network server can send a second request via, e.g., a PSTN call or a VoIP call, to the snoozing device after 15 minutes elapses. After receiving the second request, the snoozing device can provide, such as display via interface 800, a message 802 corresponding to the second request. Interface 800 can also display an animation 804, a connection icon 806, and a dismiss icon 808. Message 802 can indicate that the snoozing device received the second request, such as a PSTN call or a VoIP call, from the network server for connecting to a conference call. For example, if the delay time is 15 minutes, message 802 can indicate that the weekly meeting is “15 minute overdue.” Interface 800 can display message 802, for example, in a banner, an alert, a pop-up window, or in any other desired manners.

Similar to interface 300, interface 800 can also display animation 804, connection icon 806, and dismiss icon 808. Similar to those described above, interface 800 can also provide the user to respond to the second request by, for example, moving message 802 in different directions, such as a vertical direction or a horizontal direction, on interface 800. In some embodiments, message 802 itself is not moved, but interface 800 can provide a button (not shown) to allow a user to touch, slide, swipe, or otherwise move to respond to the second request. The manner that interface 800 can provide for responding to the second request can be the same or similar to those described above with respect to responding to the first request, and thus will not be repeated.

In some instances, a user could wish to further delay to connect to the conference call. If the mobile communications device receives a selection to further delay the connection to a conference call, the mobile communication device can send another delay notice to the network server, which can again send delay notifications to other conference call participants. It is appreciated that the number of times for delaying the connection to the conference call is not limited to the above examples and can be any number that is desired.

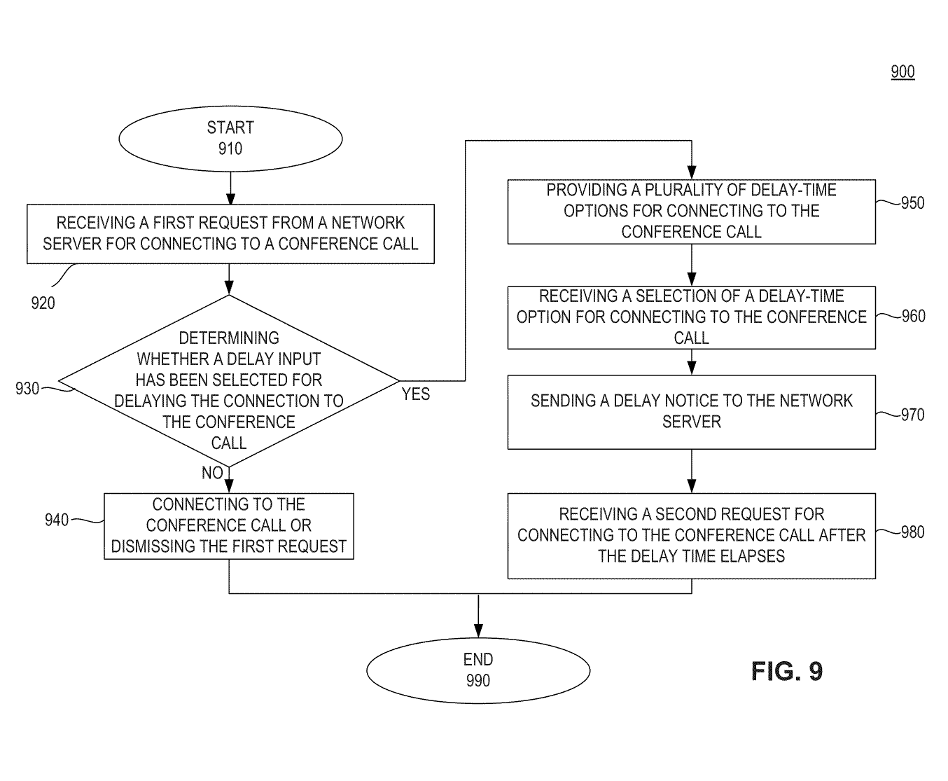

FIG. 9 is a flowchart representing an example method 900 for connecting a mobile communication device (e.g., mobile communication device 102) to a conference call. It will be readily appreciated that the illustrated procedure can be altered to delete steps or further include additional steps. After initial step 910, a mobile communication device can receive (step 920) a first request from a network server (e.g. network server 108) for connecting to a conference call at a scheduled conference time. As described above, the network server can automatically request for connection and establish communications, such as conference calls, with the mobile communication device. As an example, the network server can automatically initiate a PSTN call or a VoIP call to the mobile communication device at a scheduled conference time. Therefore, at the scheduled conference time, the user of the mobile communication device does not have to go through the burdensome process of taking many actions for connecting to the conference call, because the mobile communication device receives the request for connection to the conference call from the network server.

After receiving the first request, the mobile communication device can determine (step 930) whether a delay option has been selected for delaying the connection to the conference call. As described above, after receiving the first request for connecting to a conference call, the mobile communication device can, for example, display a message (e.g., message 302) corresponding to the first request, or provide a plurality of request responding buttons for the user to respond to the first request. A user could wish to delay connecting to the conference call for any desired reasons and therefore can respond to the first request by making corresponding input to the mobile communication device. The mobile communication device can receive and detect the input of the user. As an example, the mobile communication device can receive a user's selection to delay the connection to the conference call because the message (e.g., message 302) is being moved in a horizontal direction, or the corresponding request responding button is being selected. The mobile communication device can then determine, based on the detection, whether the user's input indicates to delay connecting to the conference call. As an example, if the message is being moved in a vertical direction (either up or down), the mobile communication device can determine that the user's input does not indicate delaying the connection to the conference call and therefore either connects to the conference call or dismisses the first request (step 940). If the message is being moved in a horizontal direction, the mobile communication device can determine that the user's input indicates to delay connecting to the conference call and proceed to the next step.

If the mobile communication device determines that the user's input indicates delaying the connection to the conference call, the mobile communication device can provide (step 950), such as display, a plurality of delay-time options for connecting to the conference call. Each of the plurality of delay-time options can provide a delay time for establishing a connection to the conference call. As described above, the delay-time options can be a plurality of delay-time buttons (e.g., 504A, 506A, and 508A) that are displayed vertically, horizontally, or in any other desired manner. The plurality of delay-time buttons can enable different delay times. For example, delay-time buttons 504A-B can enable delay for 5 minutes; delay-time buttons 506A-B can enable delay for 10 minutes; and delay-time buttons 508A-B can enable delay for 15 minutes. It is appreciated that the delay time are not limited to 5, 10, and 15 minutes, and can be any time period that is desired.

After providing the plurality of delay-time options, the mobile communication device can receive the user's selection of one of the plurality of delay-time options after, for example, the delay-time buttons that indicate the desired delay time for connecting to the conference call is being or has been touched. For example, the mobile communication device can receive a selection of a delay-time option for 10 minutes after the delay-time button that enables delay for 10 minutes is being or has been touched. The mobile communication device can then receive (step 960) the user's selection of the delay-time option by detecting the user's input.

After receiving the selection of the delay-time option, the mobile communication device can then send (step 970) a delay notice corresponding to the selected delay-time option to the network server. For example, the mobile communication device can send a delay notice to notify the network server (e.g. network server 108) of a user's delaying for 10 minutes if the user's selection of a delay-time option corresponds to a 10 minutes delay to connect to the conference call. In some embodiments, the mobile communication device can also dismiss the first request (e.g., a PSTN call or a VoIP call) after the delay notice is sent to the network server and becomes a snoozing device. In some embodiments, after the mobile communication device becomes a snoozing device, the mobile communication device can also provide a control function, such as a go-back or cancel button, so that the mobile communication device can cancel or stop snoozing. For example, the control function can enable the user to respond to the first request by either connecting to the conference call or dismissing the first request immediately, rather than wait until the end of the delay.

After step 970, after the delay time for connecting to the conference call elapses, the mobile communication device can receive (step 980) a second request from the network server for connecting to the conference call. In some embodiments, after the delay time elapses, the network server can send a second request to the mobile communication device for connecting to the conference call. As an example, if the delay time is 15 minutes, the network server can send a second request by, e.g., a PSTN call or a VoIP call, to the snoozing device after 15 minutes elapses. After receiving the second request, the mobile communication device can provide, such as display via interface 800, a message (e.g., message 802) corresponding to the second request. The message can indicate that the mobile communication device received the second request, such as a PSTN call or a VoIP call, from the network server for connecting to a conference call. For example, if the delay time is 15 minutes, the message can show that the weekly meeting is “15 minute overdue.” The message can be displayed, for example, in a banner, an alert, a pop-up window, or in any other desired manners. After step 980, process 900 can proceed to an end 990. Process 900 can also be repeated if one or more delay for connecting to the conference call needs to be provided.

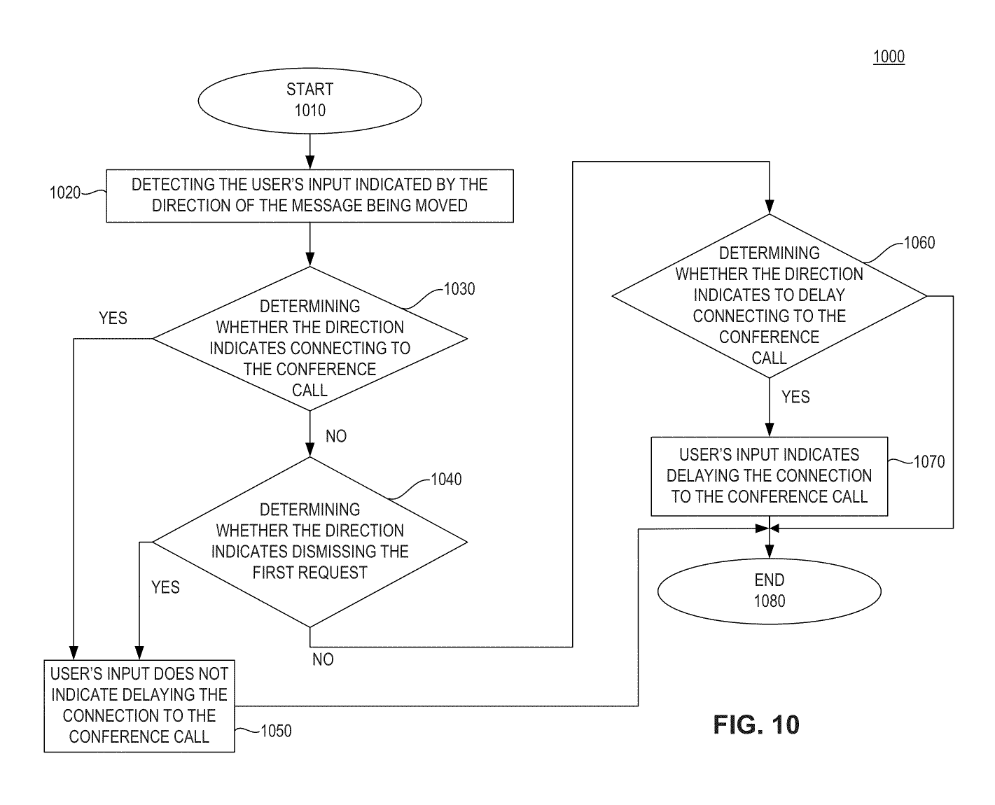

FIG. 10 is a flowchart representing an example method 1000 for determining whether the user's input indicates delaying the connection to the conference call. It will be readily appreciated that the illustrated procedure can be altered to delete steps or further include additional steps. As described above, after receiving the first request for connecting to a conference call, a mobile communication device (e.g., mobile communication device 102) can, for example, display a message (e.g., message 302) corresponding to the first request for connecting to a conference call. After initial step 1010, the mobile communication device can detect (step 1020) the user's input, which can be indicted by the direction of the message being moved. For example, the mobile communication device can detect the direction of the message by sensing the user's finger or stylus movement on an interface (e.g., interfaces 400A-C) displayed on the mobile communication device.

After detecting the received input, the mobile communication device can determine (step 1030) whether the direction of the received input indicates connecting to the conference call or (step 1040) whether it indicates dismissing the first request for connecting to the conference call. As described above, for example, if the message is being moved downwards, the mobile communicate device can determine that the direction of the received input indicates connecting to the conference call. And if the message is being moved upward, the mobile communicate device can determine that the direction of the received input indicates dismissing the first request for connecting to the conference call. If the mobile communication device determines that the directions of the received input indicate either connecting to the conference call or dismissing the first request, then the mobile communication device can determine that the received input does not indicate to delay connecting to the conference call (step 1050).

If, however, the mobile communication device determines that the received input does not indicate to either connecting to the conference call or to dismissing the first request, the mobile communication device can determine (step 1060) whether the direction of the received input indicates delaying the connection to the conference call. As described above, the mobile communication device can determine the received input indicates delaying the connection to the conference call if, for example, the message (e.g., message 302) is being moved in a horizontal direction. If the in the mobile communication device detects that the message is being moved in a horizontal direction, the mobile communication device can then determine that the received input indicates delaying the connection to the conference call (step 1070). While the user's input in the above description involves only vertical and horizontal directions, it is appreciated that the user's input can be in any directions that is desired and the mobile communication device can detect the user's input and determine whether the user's input indicates to delay connecting to the conference call in any desired manner. In some embodiments, after step 1070, process 1000 can proceed to an end 1080. In some embodiments, if the mobile communication device's received input is neither in a vertical direction nor in a horizontal direction, the mobile communication device can repeat process 1000 or can simply proceed to an end 1080. Process 1000 can also be repeated if the mobile communication device fails to determine whether the user's input indicates delaying a connection to the conference call in the first time or for any other reasons. Process 1000 can also be repeated after the mobile communication device (e.g., a snoozing device) receives a second, third, and so forth requests for connecting to the conference call.

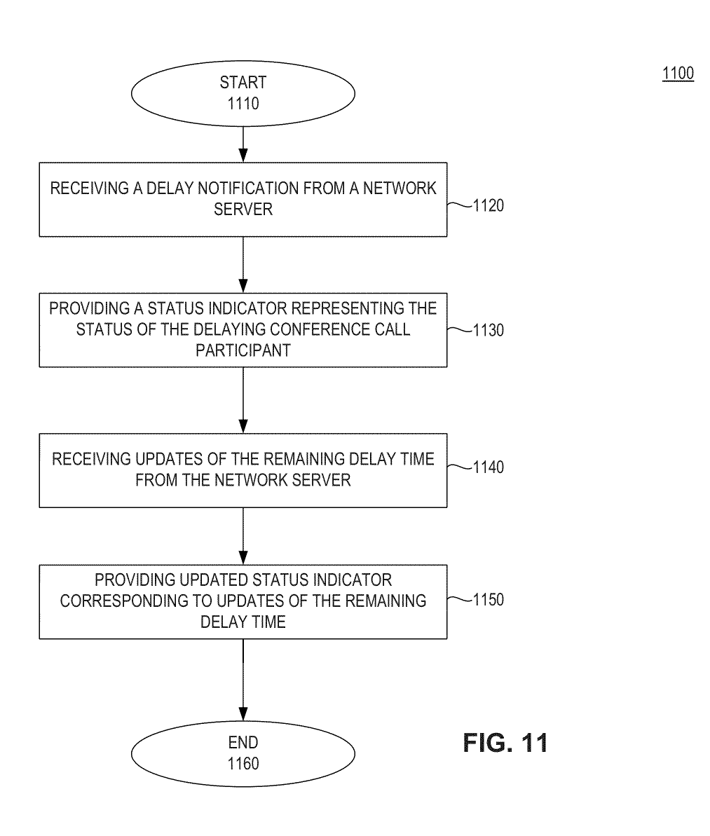

FIG. 11 is a flowchart representing an example method 1100 for indicating a status of a conference call participant on a mobile communication device. It will be readily appreciated that the illustrated procedure can be altered to delete steps or further include additional steps. After initial step 1110, a receiving mobile communication device (e.g. mobile communication device 106) can receive (1120) a delay notification from a network server. As described above, after the network server receives a delay notice from a snoozing device, it can provide a delay notification to one or more of the conference call participants. As an example, in some embodiments, the network server can transmit a delay notification to the receiving mobile communication device of the host of the conference call, indicating that the user of the snoozing device is delaying to connect to the conference call. In some embodiments, the network server can transmit a delay notification to the receiving mobile communication devices of all conference participants, notifying them that the user of the snoozing device is delaying to connect to the conference call. The delay notification sent from the network server can include, for example, the identity of a conference call participant that is delaying to connect to the conference call (i.e., the delaying conference call participant) and a delay time. As an example, a delay notification can include the name of the delaying conference call participant (e.g., Jane Doe), and a 10 minutes delay time, which indicates that the delaying conference call participant is delaying 10 minutes to connect to the conference call. In some embodiments, the mobile communication device associated with the delaying conference call participant can provide an option for designating which of the one or more participants are to receive the delay notification. For example, the mobile communication device can provide an option for the delaying conference call participant to designate that only the host receives the delay notification or can designate that all participants receive the delay notification. In some embodiments, the receiving mobile communication device associated with the host of the conference call can provide the option for designating which of the one or more participants are to receive the delay notification.

After receiving the delay notification, the receiving mobile communication device can provide a status indicator representing the status of the delaying conference call participant. As described above, in some embodiments, the status indicator can be displayed along with the identity of the delaying conference call participant (e.g., Jane Doe) in an attendee list (e.g. attendee list 702). The status indicator can also include a delay time, which indicates the delay time for the delaying conference call participant to connect to the conference call. The delay time can be displayed, for example, in a short message such as a message showing “Delayed 5 Minutes” and/or a clock icon representing the delay time. For example, the clock icon can be animated to indicate that a delaying conference call participant is delaying 10 minutes to connect to the conference call.

For those embodiments that include the attendee list, the attendee list can include a present participant list (e.g., present participant list 704) and a missing participant list (e.g., missing participant list 706). The present participant list can include a list of conference call participants that are currently present in the conference call. The missing participant list can include a list of conference call participant that are currently missing from conference call. For example, the missing participant list can include the delaying conference call participants (e.g., Jane Doe).

After providing the status indicator, the receiving mobile communication device can receive updates (step 1140) of the remaining delay time from the network server. As described above, in some embodiments, the network server can provide updates of the remaining delay time. After receiving a delay notice from a mobile communication device, which has become a snoozing device (e.g., mobile communication device 102), the network server can provide a delay notification to one or more receiving mobile communication devices (e.g., mobile communication device 106). The delay notification can include a delay time of, e.g., 5 minutes. As time passes by, the network server can also provide updates of the remaining delay time, e.g., 3 minutes, 1 minute, and so forth, to the receiving mobile communication devices. The updates can be provided, for example, in one or more updating notifications.

After receiving updates, the receiving mobile communication device can provide (step 1150) one or more updated status indicators corresponding to the updates of the remaining delay time. As described above, a receiving mobile communication device can display an updated status indicator (e.g. status indicator 728), indicating that the remaining delay time is 3 minutes; and another updated status indicator (e.g. status indicator 748), indicating that the remaining delay time is 1 minute. It is appreciated that the 3 minutes and 1 minute remaining delay time are for illustration purpose only and the receiving mobile communication device can display the status indictors corresponding to updates of any remaining delay time. For example, in some embodiments, the receiving mobile communication device can display a countdown counting down to when the snoozing device should enter the conference call. After step 1150, process 1100 can proceed to an end 1160. Process 1100 can also be repeated if the receiving mobile communication device receives more delay notifications and/or updates of the remaining delay time from the network server.

As described above, after the mobile communication device receives a first request for connecting to the conference call at the scheduled conference time, the mobile communication device (e.g., mobile communication device 102) can become a snoozing device if the mobile communicate device determines that the received input indicates delaying the connection to the conference call. In some embodiments, a mobile communication device can also become a snoozing device if the mobile communication device determines that the received input indicates delaying the connection to the conference call, after the mobile communication device receives a reminder from, e.g., a calendar function included in software applications 234 or from a network server. For example, 15 minutes before the schedule conference time, the mobile communication device can receive and display a reminder for connecting to the conference call. The reminder can include a connection option, which can include a conference call dial-in number or an Internet address, for connecting to the conference call. Thus, the mobile communication device can enable connecting to the conference call at the scheduled conference time, if the connection option is being selected, such as being touched or clicked on. The reminder can also include a dismiss option for dismissing the reminder. Thus, the mobile communication device can enable dismissing the conference call, if the dismiss option is being selected, such as being touched or clicked on.

Moreover, the reminder can also include one or more delay-time options for delaying to connect to the conference call. The delay-time option can be the same or similar to those described above. After the mobile communication device receives a delaying conference call participant's selection of the delay-time option, a delay notice can also be sent to the network server. Moreover, the mobile communication device can also provide an option for the delaying conference call participant to designate that the delay notice be sent to only the host of the conference call or all conference call participants. The process of receiving the selection of a delay-time option and sending a delay notice can be the same or similar to those described above and will not be repeated.

Furthermore, after the network server receives the delay notice, the network server can then send delay notifications to the other conference call participants; and status indicators can be provided, such as displayed, on the receiving mobile communication devices. The process of receiving delaying notifications and providing status indicators can be the same or similar to those described above and will not be repeated.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software, firmware, or hardware sections or modules can be integrated into a computer system or existing communications software.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps and/or inserting or deleting steps. It is intended, therefore, that the specification and examples be considered as example only, with a true scope and spirit being indicated by the following claims and their full scope of equivalents.

What is claimed is:

1. A method performed by a mobile communication device having one or more processors, the method comprising:
displaying a message associated with a received first request for establishing a connection to a conference call;
receiving, on the mobile communication device, a delay option selection;
displaying, based on the received delay option selection, a plurality of delay-time options, each of the plurality of delay-time options providing a delay time for establishing a connection to the conference call; and
receiving a selection of one of the plurality of delay-time options associated with a time for establishing a connection to the conference call.

2. The method of claim 1, further comprising receiving, on the mobile communication device, the first request from a network server.

3. The method of claim 2, wherein receiving, on the mobile communication device, the delay option selection further comprises:
detecting, on the mobile communication device, a direction of the message being moved; and
determining, based on the detected direction, that a delay option has been selected.

4. The method of claim 3, further comprising:
providing, on the mobile communication device, a connection option for establishing a connection with a network server and a dismiss option for dismissing the first request.

5. The method of claim 1, wherein the plurality of delay-time options enable different delay times.

6. The method of claim 5, wherein displaying the plurality of delay-time options further comprises displaying the plurality of delay-time buttons vertically or horizontally.

7. The method of claim 6, wherein receiving the selection of one of the plurality of delay-time options comprises detecting an input selecting one of the plurality of delay-time buttons.

8. The method of claim 1, further comprising sending a delay notice corresponding to the selected delay-time option to a network server.

9. The method of claim 8, further comprising receiving a second request for connecting to the conference call after the delay time for connecting to the conference call elapses.

10. A mobile communication device comprising:
a display;
one or more computer-readable storage media enabled to store instructions; and
one or more processors enabled to execute the instructions causing the mobile communication device to:
display, on the display, a message associated with a received first request for establishing a connection to a conference call,
receive a delay option selection,
display, based on the received delay option selection, on the display a plurality of delay-time options, each of the plurality of delay-time options providing a delay time for establishing a connection to the conference call, and
receive a selection of one of the plurality of delay-time options associated with a time for establishing a connection to the conference call.

11. The mobile communication device of claim 10, wherein the one or more processors are enabled to execute further instructions causing the mobile communication device to display the plurality of delay-time options vertically.

12. The mobile communication device of claim 10, wherein the one or more processors are enabled to execute further instructions causing the mobile communication device to display the plurality of delay-time options horizontally.

13. The mobile communication device of claim 10, wherein the one or more processors are enabled to execute further instructions causing the mobile communication device to send a delay notice corresponding to the selected delay-time option to a network server.

14. The mobile communication device of claim 13, wherein the one or more processors are enabled to execute further instructions causing the mobile communication device to receive a second request for connecting to the conference call after the delay time for connecting to the conference call elapses.

15. The mobile communication device of claim 10, wherein the one or more processors are enabled to execute instructions causing the mobile communication device to receive the delay option selection further comprises:
the one or more processors are enabled to execute further instructions causing the mobile communication device to detect a direction of the message being moved and determine, based on the detected direction, that a delay option has been selected.

16. The mobile communication device of claim 15, wherein the one or more processors are enabled to execute further instructions causing the mobile communication device to provide a connection option for establishing a connection with a network server and a dismiss option for dismissing the first request.

17. The mobile communication device of claim 10, wherein the plurality of delay-time options enable different delay times.

18. A non-transitory computer readable storage medium storing a set of instructions that are executable by at least one processor of a mobile communication device to cause the mobile communication device to perform a method, the method comprising:
displaying a message associated with a received first request for establishing a connection to a conference call;
receiving, on the mobile communication device, a delay option selection;
displaying, based on the received delay option selection, a plurality of delay-time options, each of the plurality of delay-time options providing a delay time for establishing a connection to the conference call; and
receiving a selection of one of the plurality of delay-time options associated with a time for establishing a connection to the conference call.
